(19) United States
(12) Patent Application Publication
(10) Pub. No.: US 2019/0092650 A1
(43) Pub. Date: Mar. 28, 2019

(54) PRE-TREATMENT OF A DESALINATION PROCESS FEED

(71) Applicant: TAFILA TECHNICAL UNIVERSITY, Tafila (JO)

(72) Inventors: AIMAN EID AL-RAWAJFEH, Al-Tafila (JO); AHMAD AL-MAABERAH, Al-Tafila (JO); MOHAMMED ZAITOUN, Al-Kerak (JO)

(21) Appl. No.: 15/713,982

(22) Filed: Sep. 25, 2017

(51) Int. Cl. C02F 1/26; C08J 5/22; C01B 32/50

(52) U.S. Cl. CPC C02F 1/265; C02F 1/4604; C01B 32/50; C08J 5/22

(57) ABSTRACT

Pre-treatment of an input feed in a desalination process includes splitting the input feed into two streams, a first stream and a second stream, passing the second stream through a nano-filtration unit to produce a softened second stream, combining the softened second stream and the first stream, and feeding the combined streams to a desalination process. An apparatus for pre-treatment of an input feed in a desalination process includes an adsorption unit for splitting the input feed into two streams, a first stream rich in sodium ions and a second stream rich in calcium and magnesium ions, a nano-filtration unit to receive the second stream to produce a softened second stream, and a combiner for combining the softened second stream and the first stream, and feeding the combined streams to a desalination process.

### TECHNICAL FIELD

The present disclosure relates generally to a water desalination process, and more particularly, to a method and apparatus for pre-treatment of a desalination process feed.

### BACKGROUND

Desalination (also referred to as “desalinization” and “desalting”) is the process of removing dissolved salts from water, thus producing fresh water from seawater, brackish water, or other elevated salinity water as sources. Desalting technologies can be used for many applications.

A growing worldwide need for fresh water for potable, industrial, and agricultural uses has led to an increase in the need for purification methods that use seawater, brackish water, or other elevated salinity water as sources. Desalination has become a more popular option in regions where there is abundant water that is unsuitable for use due to high salinity, and there are opportunities for desalination plants, or systems, that utilize thermal, electrical, or mechanical energy to separate the water from the salts. The choice of the desalination process depends on many factors, including salinity levels in the desalination feed, quantities of water needed, and the form of available energy.

The purification of high salinity water through the removal of dissolved solids, such as salts, has been accomplished in several ways, including distillation and reverse osmosis (“RO”). These methods start with a pretreated feed of the high salinity water and then purify (e.g., desalt) the water to a desired level (e.g., suitable for human consumption or other purposes).

Multi-stage flash distillation (“MSFD”) is the major desalination process used worldwide. Alone, it accounts for about 48% of total world desalination capacity as compared to 36% produced by the reverse osmosis (“RO”) process. The remainder (16%) is produced by a variety of processes, primarily Electro Dialysis (“ED”), Multiple Effect Distillation (“MED”), and Vapor Compression Distillation (“VCD”). Saudi Arabia is the leading user of MSFD, and the United States is the largest user of the RO process. The MSFD, MED, and VCD processes are used exclusively in sea water desalination, while ED is applied in brackish water desalination and pure water preparation. The RO process is applied to both sea water and brackish water feeds, but in the past, its application was primarily in brackish water, drinking water, and in pure water preparation.

The presence of high salts of calcium and magnesium in the desalination feed results in a lot of problems with the machinery used in the desalination plant, or system. Fouling of such machinery includes mineral scale formation, gel-layer formation, colloidal deposition and pore plugging, and biological fouling. Scaling and gel-layer formation, which respectively relate to sparingly soluble inorganic and organic matter, is exacerbated by concentration polarization, which refers to the accumulation of rejected materials next to the membrane surface. Fouling impairs membrane performance and shortens its life.

Sealants are low-solubility salts whose precipitation onto the membrane is promoted by the conversion of water into permeate, and further encouraged by both concentration polarisation and the pH shift produced by carbon dioxide permeation. The formed scale can reduce the membrane permeability and permselectivity. As with colloidal and particulate fouling, scaling is also a problem in membrane filtration processes. Any water containing calcium carbonate close to or beyond its thermodynamic saturation limit, as is the case for many dairy and pharmaceutical effluents, can produce calcite (the most common crystal form of calcium carbonate) at the membrane surface.

The solubility product represents the maximum value of the product of the molar concentrations of the two component ions of the salt. If the solubility is exceeded, then the salt will precipitate. A general rule of thumb for avoiding precipitation is that the ionic product should not exceed 80% of the solubility product.

The appropriate constants for thermodynamic equilibrium appropriate to some of the more common sealants, such as salts of the divalent alkaline earth elements of magnesium, calcium, and barium, are normally included in computer aided design (“CAD”) packages for designing RO arrays. The thermodynamic relationships include, in the case of calcium carbonate formation, data pertaining to hydrolysis. A significance of this is outlined herein.

Calcium carbonate is very insoluble in water, and readily precipitates to form a scale on pipework, heat transfer surfaces, and membranes.

When carbon dioxide dissolves in water, it forms carbonic acid, which dissociates producing acid and bicarbonate ions thus: this is the origin of the pH shift in reverse osmosis. Because the membrane allows free passage of carbon dioxide, the CO₂/HCO₃ ratio in the permeate is high and that of the retentate low. Bicarbonate ions further dissociate to carbonate.

There were some methods used for pre-treatment of the desalination input feed, such as lowering the working temperature, softening by ion-exchangers, nano-filtration, acidification, and using anti-scalants. However, none of them were very effective and cost competitive.

In view of the disadvantages inherent in the methods and apparatuses for desalination, there is a desire for an improved method and apparatus for pre-treatment of a desalination process input feed, which is inexpensive, compact, and capable of overcoming disadvantages inherent in the above-mentioned methods and apparatuses for desalination in a cost effective, secure, and environmental friendly manner.

### SUMMARY

Embodiments of the present disclosure provide a method and apparatus for pre-treatment of a desalination process input feed having advantages not taught by the prior art.

Embodiments of the present disclosure provide for pre-treatment of a desalination input feed in a desalination process, including splitting the input feed into a first stream and a second stream, passing the second stream through a nano-filtration unit to produce a softened second stream, combining the softened second stream and the first stream, and feeding the combined streams to a desalination process.

In an aspect of the present disclosure, the first stream includes a sodium ions rich stream.

In an aspect of the present disclosure, the second stream includes a calcium ions and magnesium ions rich stream.

In embodiments of the present disclosure, the nano-filtration unit softens the calcium and magnesium ions and eliminates the bicarbonate and carbonate ions from the second stream.

In an aspect of the present disclosure, the input feed is split using an adsorption unit. In embodiments of the present disclosure, the adsorption unit includes a synthetic or a natural material, or a combination of these

In an aspect of the present disclosure, the adsorption unit also serves as a CO₂ deaeration unit to decrease a release rate of carbon dioxide in the desalination process.

Aspects of the present disclosure provide for pre-treatment of a desalination input feed in a desalination process, including an adsorption unit for splitting the input feed into two streams, a first stream rich in sodium and a second stream rich in calcium and magnesium, a nano-filtration unit to receive the second stream to produce a softened second stream, and a combiner for combining the softened second stream and the first stream, and feeding the combined streams to a desalination process.

For a better understanding of the disclosure, its operating advantages and the specific objects attained by its uses, reference should be had to the accompanying drawings and descriptive matter in which there are illustrated exemplary embodiments of the disclosure.

### BRIEF DESCRIPTION OF THE DRAWINGS

FIG. 1 illustrates a schematic diagram of a prior art desalination system;

FIG. 2 illustrates a flowchart diagram of a pre-treatment of a desalination input feed, according to embodiments of the present disclosure; and

FIG. 3 illustrates a schematic diagram of an apparatus for pre-treatment of a desalination input feed, according to embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details.

As used herein, the term “plurality” refers to the presence of more than one of the referenced item, and the terms “a,” “an,” and “at least” do not denote a limitation of quantity, but rather denote the presence of at least one of the referenced item.

The terms “feed” or “desalination feed,” or “input feed” or “input desalination feed” may he interchangeably used in the below description conveying the same meaning.

In an exemplary embodiment, the present disclosure provides a method and apparatus for pre-treatment of the desalination feed for a desalination process. The apparatus and method of the present disclosure may be used for mass production in an easy, cost effective, environmental friendly and productive way.

It is to be understood that the improvements of the present disclosure are applicable to any of a number of apparatuses and methods of pre-treatment of the desalination feed for a desalination process, other than those which are specifically described below. Such methods and apparatuses will be readily understood by the person of ordinary skill in the art, and are achievable by causing various changes that are themselves known in state of the art.

Reference herein to “one embodiment” or “another embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments mutually exclusive of other embodiments. Further, the order of steps in process flowcharts or diagrams representing one or more embodiments of the disclosure do not inherently indicate any particular order nor imply any limitations in the disclosure.

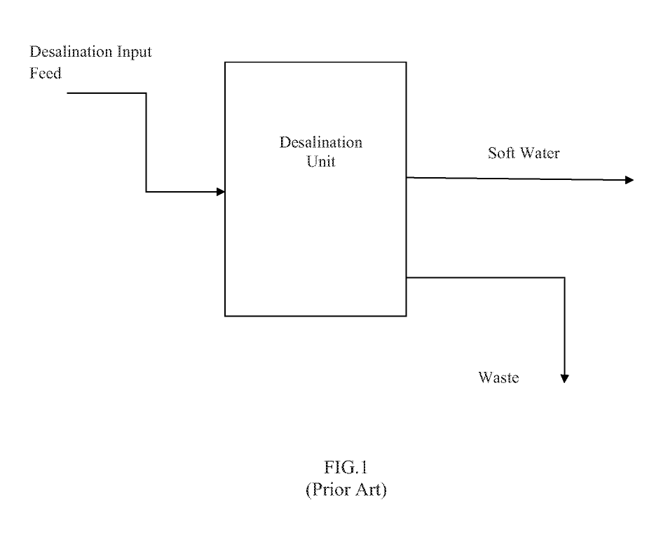

FIG. 1 illustrates a schematic diagram of a prior art desalination system. The desalination system is provided with a desalination feed as input. The input feed can be seawater, brine, brackish water, wastewater, and any mixed salty water containing sodium ions, calcium ions, and/or magnesium ions, which are to be softened by the process of desalination. This input feed is fed to the desalination unit, which may be based on thermal or reverse osmosis or hybrid or any similar technology known in the art for desalination. The output of the desalination unit is the soft water as required and waste in the form of salt precipitates.

The limitation of this process is the supply of high salt contents to the desalination system, which results in several disadvantages such as scaling of various desalination plant equipment, thereby reducing its life and the efficiency of the desalination process. The presence of high amounts of calcium ions and magnesium ions in the input feed is undesirable; however, the presence of sodium ions is acceptable.

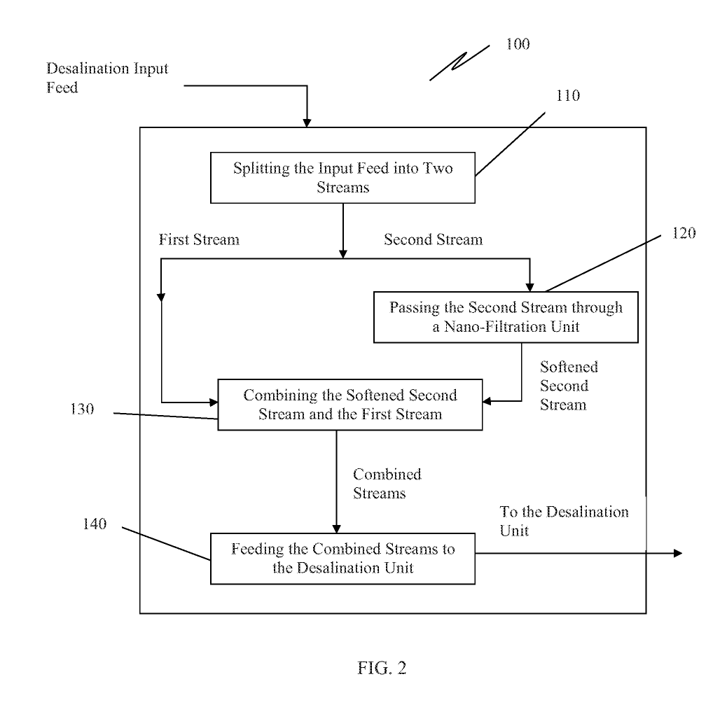

Referring to FIG. 2, there is illustrated a flowchart diagram of a method 100 of pre-treatment of a desalination input feed before being processed by a desalination unit, according to embodiments of the present disclosure. The method 100 begins with the step 110 of splitting the input feed into two streams, a first stream and a second stream. The desalination input feed may be one of seawater, brine, brackish water, wastewater, mixed salty water containing Na⁺, Ca⁺², and Mg⁺², or a combination of these.

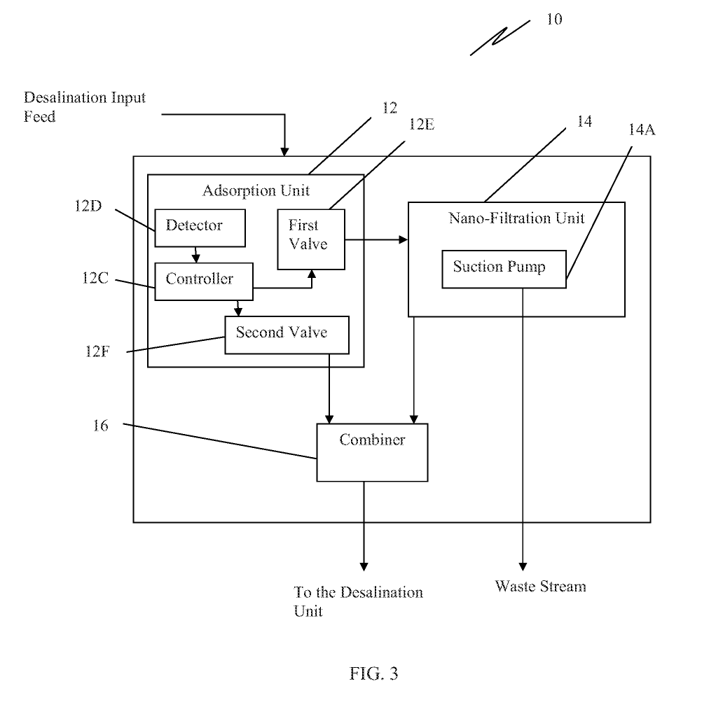

In one embodiment of the present disclosure, the desalination input feed is split using an adsorption unit (see FIG. 3). The adsorption unit splits the input feed into a first stream, which is a sodium ions rich stream, and a second stream, which is a calcium ions and magnesium ions rich stream. In one embodiment of the present disclosure, the adsorption unit includes one of a synthetic material, a natural material, or a combination thereof to split the input feed into two streams. In one embodiment, the adsorbents may include Zeolites and/or a synthetic mixed resin.

The first stream, which is a sodium ions rich stream, may be directly fed to the thermal or membrane unit based on the technology used for the desalination process. In step 120, the second stream, which is rich in calcium ions and magnesium ions, is passed through a nano-filtration unit (see FIG. 3) to produce a softened second stream. In one embodiment of the present disclosure, the nano-filtration unit softens the calcium and magnesium ions in the second stream and eliminates bicarbonate and carbonate ions from the second stream. The second stream coming out from the nano-filtration unit is referred as the “softened second stream.” The nano-filtration unit may use technologies available in the art to soften the second stream and achieve the desired result as explained.

In step 130, the first stream and the softened second stream are combined to form a combined stream (also referred to herein as the “combined streams”). The combined stream is fed to further steps of the desalination process in step 140. The combined stream is fed to the desalination unit instead of the original input feed, which was previously described with respect to FIG. 1. The desalination unit may use a thermal, reverse osmosis (“RO”), or hybrid (RO and thermal) process (or any other commercially available desalination process) to desalinate the combined stream.

The combined stream contains null or less harmful scale producing species than the original input feed. The input feed is made free or partially free of this harmful scale producing species by exchanging them with less harmful and non-scaling species, such as sodium ions. The calcium and magnesium ions are exchanged with sodium ions, which are less harmful in terms of producing scales.

In one embodiment of the present disclosure, the adsorption unit may also serve as a CO₂ de-aeration unit to decrease a release rate of carbon dioxide in the desalination process. The adsorbent removes the carbonate and bicarbonate from the feed water and then this, consequently, reduces the amount of CO₂ released in the desalination step later on.

Referring to FIG. 3, there is illustrated a schematic diagram of an apparatus 10 for pre-treatment of an input feed in a desalination system, according to one embodiment of the present disclosure. The method 100 may be performed using the apparatus 10. The apparatus 10 includes an adsorption unit 12 for splitting the input feed into two streams, a first stream rich in sodium ions and a second stream rich in calcium and magnesium ions, a nano-filtration unit 14 to receive the second stream to produce a softened second stream, and a combiner 16 for combining the softened second stream and the first stream and feeding the combined stream to a desalination unit.

In one embodiment of the present disclosure, the adsorption unit 12 includes a detector 12D configured to detect the sodium, calcium and/or magnesium ions in the input feed, and a controller 12C, operating in response to the detector 12D, configured to split the input feed into two separate streams based on its contents.

In one embodiment of the present disclosure, the detector 12D may include an ion selective electrode available in the art that can detect dissolved ions according to their size and valence. For example, the electrode may be sensitive to sodium ions and can detect the concentration of sodium ions in the input feed. Examples of such electrodes may include, but are not limited to, a Mettler Toledo perfectION™ comb Ca Combination Electrode, model no. 51344703, or a perfectION™ comb Na Combination Electrode, model no. 51344724.

In one embodiment, the controller 12C may be operably connected to the detector 12D, a first valve 12E, and a second valve 12F. The controller 12C may be configured to open the first valve 12E and close the second valve 12F when the concentration of sodium ions in the input feed, as detected by the detector 12D, reaches a threshold value. The stream passing through the first valve 12E may he the first stream. When the concentration of sodium ions in the input feed is less than the threshold value, the controller 12C may be configured to close the first valve 12E and open the second valve 12F. The stream passing through the second valve 12F may be the second stream.

The first stream is rich in sodium ions and the second stream is rich in calcium and magnesium ions. The nano-filtration unit 14 softens the calcium and magnesium ions and eliminates bicarbonate and carbonate ions from the second stream to provide the softened second stream.

The nano-filtration unit 14 may include a polymeric membrane having porosity in the nano-scale, and a suction pump 14A. The porosity of the polymeric membrane may permit sodium ions to pass through, while blocking the passage of calcium ions, magnesium ions, carbonate ions, and bicarbonate ions. An example of such a polymeric membrane includes, but is not limited to, the commercially available polymeric membrane DOW FILMTEC™ NF90-4040, a polyamide thin-film composite with a pore size ranging between 10-20 Å. The suction pump 14A may be configured to force the blocked ions to go through a waste stream to leave the apparatus 10 of the present disclosure.

The combiner 16 receives the first stream from the adsorption unit 12 and the softened second stream from the nano-filtration unit 14 and mixes them to produce a combined stream which is then supplied for the next step of the desalination process (e.g., a desalination unit, such as described with respect to FIGS. 1 and 2).

The method 100 and the apparatus 10 of the present disclosure provide the following advantages as compared to traditional desalination methods:
partially exchanges the scaling species by a non-scaling species;
the exchange, also referred to as regeneration, is automatic and does not need the desalination plant to stop working;
saves the time of regeneration and makes the process continuous;
saves the cost and chemicals of regeneration; and
is environmentally friendly.

The method 100 and apparatus 10 of the present disclosure may be installed as a pre-treatment process by installing a large column between the desalination input feed supply and the desalination unit using MSF, MED, RO, ED, NF, or any other commercially available technology for desalination. It may be noted that a sophisticated mechanism including sensors, motors, micro-controllers, and related components may also be used to automatically control the operations of the apparatus 10 and/or the method 100 of the present disclosure based on the requirements described herein.

Although particular exemplary embodiments of the disclosure have been disclosed in detail for illustrative purposes, it will be recognized to those skilled in the art that variations or modifications of the disclosed disclosure, including the rearrangement in the configurations of the parts, changes in sizes and dimensions, and variances in terms of shape may be possible. Accordingly, the disclosure is intended to embrace all such alternatives, modifications, and variations as may fall within the spirit and scope of the present disclosure,

The foregoing descriptions of specific embodiments of the present disclosure have been presented for purposes of illustration and description. They are not intended to be exhaustive or to limit the disclosure to the precise forms disclosed, and obviously many modifications and variations are possible in light of the above teaching. The embodiments were chosen and described in order to best explain the principles of the disclosure and its practical application, to thereby enable others skilled in the art to best utilize the disclosure and various embodiments with various modifications as are suited to the particular use contemplated. It is understood that various omissions, substitutions, or equivalents are contemplated as circumstance may suggest or render expedient, but is intended to cover the application or implementation without departing from the spirit or scope of the claims of the present disclosure.

What is claimed is:

1. A method for pre-treatment of a desalination input feed in a desalination process, comprising:
splitting the desalination input feed into two streams, a first stream and a second stream;
passing the second stream through a nano-filtration unit to produce a softened second stream;
combining the softened second stream and the first stream; and
feeding the combined streams to a desalination process.

2. The method according to claim 1, wherein the desalination input feed is selected from the group consisting of seawater, brine, brackish water, wastewater, mixed salty water containing Na⁺, Ca⁺², and Mg⁺², and a combination thereof.

3. The method according to claim 1, wherein the first stream includes a sodium ions rich stream.

4. The method according to claim 1, wherein the second stream includes a calcium and a magnesium ions rich stream.

5. The method according to claim 4, wherein the nano-filtration unit softens the calcium and magnesium ions and eliminates bicarbonate and carbonate ions from the second stream.

6. The method according to claim 1, wherein the desalination input feed is split using an adsorption unit.

7. The method according to claim 6, wherein the adsorption unit is selected from the group consisting of a synthetic material, a natural material, and a combination thereof.

8. The method according to claim 6, wherein the adsorption unit is further configured as a CO₂ de-aeration unit to decrease a release rate of carbon dioxide in the desalination process.

9. An apparatus for pre-treatment of a desalination input feed in a desalination system, comprising:
an adsorption unit configured to split the desalination input feed into two streams, a first stream rich in sodium ions and a second stream rich in calcium and magnesium ions;
a nano-filtration unit configured to receive the second stream and produce a softened second stream; and
a combiner configured to combine the softened second stream and the first stream, and to feed the combined streams to a desalination unit.

10. The apparatus according to claim 9, wherein the adsorption unit includes:
a detector configured to detect the sodium, calcium, and magnesium ions in the desalination input feed; and
a controller configured to split the desalination input feed into two separate streams based on contents of the desalination input feed.

11. The apparatus according to claim 9, wherein the desalination input feed is selected from the group consisting of seawater, brine, brackish water, wastewater, mixed salty water containing Na⁺, Ca⁺², and Mg⁺², and a combination thereof.

12. The apparatus according to claim 9, wherein the nano-filtration unit is configured to soften the calcium and magnesium ions and eliminate bicarbonate and carbonate ions from the second stream.

13. The apparatus according to claim 9, wherein the adsorption unit is selected from the group consisting of a synthetic material, a natural material, and a combination thereof.

14. The apparatus according to claim 9, wherein the adsorption unit is further configured as a CO₂ de-aeration unit to decrease a release rate of carbon dioxide in a desalination process performed within the desalination unit.

15. A desalination system comprising:
an adsorption unit configured to split a desalination input feed into two streams, a first stream rich in sodium ions and a second stream rich in calcium and magnesium ions;
a nano-filtration unit configured to receive the second stream and produce a softened second stream; and
a combiner configured to combine the softened second stream and the first stream, and to feed the combined streams to a desalination unit.

16. The system according to claim 15, wherein the adsorption unit includes:
a detector configured to detect the sodium, calcium, and magnesium ions in the desalination input feed; and
a controller configured to split the desalination input feed into two separate streams based on contents of the desalination input feed.

17. The system according to claim 15, wherein the desalination input feed is selected from the group consisting of seawater, brine, brackish water, wastewater, mixed salty water containing Na⁺', Ca⁺², and Mg⁺² , and a combination thereof.

18. The system according to claim 15, wherein the nano-filtration unit is configured to soften the calcium and magnesium ions and eliminate bicarbonate and carbonate ions from the second stream.

19. The system according to claim 15, wherein the adsorption unit is further configured as a CO₂ de-aeration unit to decrease a release rate of carbon dioxide in a desalination process performed within the desalination unit.
